(19) United States
(12) Patent Application Publication
(10) Pub. No.: US 2010/0091064 A1
(43) Pub. Date: Apr. 15, 2010

(54) IMAGE FORMING APPARATUS AND IMAGE FORMING METHOD

(75) Inventors: Masatoshi Araki, Kanagawa (JP); Satoshi Mohri, Kanagawa (JP); Manabu Numata, Kanagawa (JP); Hiroshi Ikeda, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/404,476

(22) Filed: Mar. 16, 2009

(30) Foreign Application Priority Data
Oct. 10, 2008 (JP) 2008-263638

(51) Int. Cl. B41J 2/015

(52) U.S. Cl. 347/21

(57) ABSTRACT

An image forming apparatus includes: a supply unit that supplies liquid absorbing particles to receive a liquid; a transporting unit that transports the liquid absorbing particles supplied by the supply unit; and a ejecting unit that ejects liquid droplets to the liquid absorbing particles transported by the transporting unit, the ejecting unit having: an ink ejecting part that ejects ink; and a dampening solution ejecting part that ejects a dampening solution to dampen the liquid absorbing particles, the ink ejecting part being provided on an upstream side of the dampening solution ejecting part in an image forming direction.

### CROSS-REFERENCE TO RELATED APPLICATION

This application is based on and claims priority under 35 USC 119 from Japanese Patent Application No. 2008-263638 filed Oct. 10, 2008.

### BACKGROUND

1. Technical Field

The present invention relates to an image forming apparatus and an image forming method.

2. Related Art

In an image forming apparatus, a novel method using inkjet printing has been proposed.

### SUMMARY

According to an aspect of the invention, there is provided an image forming apparatus including: a supply unit that supplies liquid absorbing particles to receive a liquid; a transporting unit that transports the liquid absorbing particles supplied by the supply unit; and a ejecting unit that ejects liquid droplets to the liquid absorbing particles transported by the transporting unit, the ejecting unit having: an ink ejecting part that ejects ink; and a dampening solution ejecting part that ejects a dampening solution to dampen the liquid absorbing particles, the ink ejecting part being provided on an upstream side of the dampening solution ejecting part in the liquid absorbing particles transporting direction of the transporting unit.

### BRIEF DESCRIPTION OF THE DRAWINGS

Exemplary embodiments of the present invention will be described in detail based on the following figures, wherein:

FIG. 1 is a cross-sectional view showing an image forming apparatus according to a first exemplary embodiment of the present invention;

FIG. 2 is a plan view showing a full-line type inkjet recording device in the first exemplary embodiment of the present invention;

FIG. 3 is a plan view showing a scan-type inkjet recording device in the first exemplary embodiment of the present invention;

FIG. 4 is a conceptual diagram showing an example of a liquid absorbing particle in the first exemplary embodiment of the present invention;

FIG. 5 is a conceptual diagram showing another example of the liquid absorbing particle in the first exemplary embodiment of the present invention;

FIG. 6A is a conceptual diagram showing a state in which ink is discharged and then a dampening solution is discharged with the amount of total 100% droplet discharge;

FIG. 6B is a conceptual diagram showing a state in which the dampening solution is discharged and then the ink is discharged with the amount of total 100% droplet discharge;

FIG. 7 is a line chart showing a comparison of variation of optical density with respect to ink droplet discharge amount between the case where the ink is discharged and then the dampening solution is discharged and the case where the dampening solution is discharged and then the ink is discharged;

FIG. 8A is a conceptual diagram showing a solid secondary color recording with the amount of e.g. cyan 100% and magenta 100% droplet discharge, i.e., the amount of total 200% droplet discharge;

FIG. 8B is a conceptual diagram showing a solid primary color recording with the amount of e.g. cyan 100% and the dampening solution 100% droplet discharge, i.e. total 200% droplet discharge;

FIG. 9A is a conceptual diagram showing the case where the ink is discharged and then the dampening solution is discharged for formation of a single color solid image with a predetermined liquid droplet amount;

FIG. 9B is a conceptual diagram showing the case where the dampening solution is discharged and then the ink is discharged for formation of a single color solid image with the same amount as the liquid droplet amount in FIG. 9A;

FIG. 10 is a line chart showing the relation between value K and ink liquid volume to obtain respective dot size;

FIG. 11A is a photograph showing a state where a character is formed with a predetermined liquid droplet amount in the case where the ink is discharged and then the dampening solution is discharged;

FIG. 11B is a photograph showing a state where a character is formed with the same amount as the liquid droplet amount in FIG. 11A in the case where the dampening solution is discharged and then the ink is discharged; and

FIG. 12 is a cross-sectional view showing the image forming apparatus according to a second exemplary embodiment of the present invention.

### DETAILED DESCRIPTION

Next, exemplary embodiments of the present invention will be described based on the drawings.

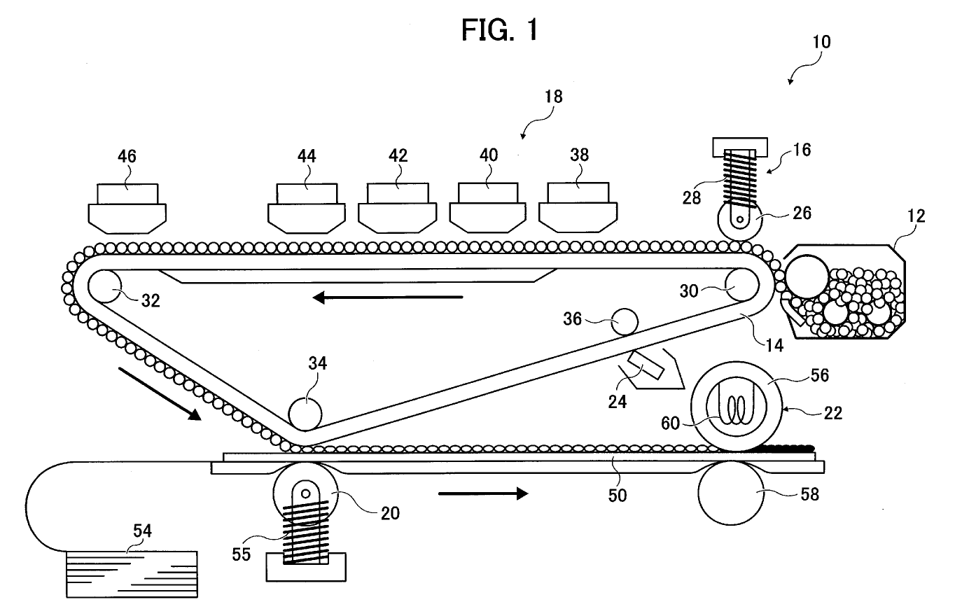

FIG. 1 schematically shows an image forming apparatus 10 according to a first exemplary embodiment of the present invention. The image forming apparatus 10 has a particle supplying device 12 as a supply unit, an intermediate transfer member 14 as a transporting unit, a pressure part 16, as a pressure unit, an inkjet recording device 18 as a ejecting unit, a transfer roll 20 as a transfer unit, a fixing device 22 as a fixing unit, and a cleaning device 24 as a cleaning unit.

The particle supplying device 12 supplies liquid absorbing particles to receive liquid to the intermediate transfer member 14. In the present exemplary embodiment, a two-component method of charging the liquid absorbing particles by stirring carrier and the liquid absorbing particles is employed. The two-component method is similar to two-component developing method in electrophotographic developing.

As indicated with an arrow in FIG. 1, the intermediate transfer member 14 is rotated in a counterclockwise direction, to attract the liquid absorbing particles supplied from the particle supplying device 12 with an electrostatic force and transport the liquid absorbing particles. In the present exemplary embodiment, the intermediate transfer member 14 having an endless belt shape is formed with a semiconductor material having a surface resistance of 10¹⁰ Ω/□ to 10¹⁴ Ω/□ and a volume resistance of 10⁹ Ω·cm to 10¹³ Ω·cm, or an insulating material having a surface resistance of 10¹⁴ Ω/□ or higher and a volume resistance of 10¹³ Ω·cm or higher. Further, as the material of the intermediate transfer member 14, a material having mechanical strength and flexibility is selected from e.g. polyimide, polyamide imide, aramid resin, polyethlene terephthalate, polyester, polyether sulphone, stainless steel and the like.

The pressure part 16 applies pressure to the layer of the liquid absorbing particles transported by the intermediate transfer member 14. The pressure part 16 is formed with e.g. a pressure member 26 and a pressing member 28 such as a spring to press the pressure member 26. As the pressure member 26 having e.g. a roller shape, a metal roller, an elastic roller having an elastic layer formed on a metal shaft, or the like, is employed.

As the metal roller, e.g., a roller of stainless steel, aluminum, iron or the like can be used. In the case of an elastic roller, as the metal shaft, similarly, e.g., a shaft of stainless steel, aluminum, iron or the like, can be used. On the other hand, as the elastic layer, a resin material, a rubber material or the like can be employed. Further, a foamed material may be applied to the elastic layer, or a conductive material may be included in the elastic layer so as to obtain conductivity.

Further, the surface of the pressure member 26 may be coated with solid lubricant or the like.

As the resin material, e.g., acrylic resin, cellulosic resin, polyamide resin, methoxymethylated nylon, ethoxymethylated nylon, polyurethane resin, polycarbonate resin, polyester resin, polyethylene resin, polyvinyl resin, polyallylate resin, polythiophene resin, styrene-butadiene resin and the like may be used.

As the rubber material, e.g., EDPM, polybutadiene rubber, natural rubber, polyisobutylene rubber, SBR (styrene-butadiene copolymer rubber), CR (chloroprene rubber), NBR (acrylonitrile-butadiene copolymer rubber), silicone rubber, urethane rubber, epichlorohydrin rubber, SBS (styrene-butadiene-styrene copolymer rubber), thermoplastic elastomer, norbornene rubber, fluorosilicone rubber, ethylene oxide rubber, isoprene rubber, epoxy rubber, and the like may be used.

As the conductive material, electronic conductive materials and ion conductive materials can be used. As the electronic conductive material, e.g., micro powder of carbon blacks such as ketjen black, acetylene black and pyrolysis carbons, graphite, various conductive metals or alloys such as aluminum, copper, nickel and stainless steel, various conductive metal oxides such as tin oxide, indium oxide, titanium oxide, tin oxide-antimony oxide solid solution and tin oxide-indium oxide solid solution, surface-conductive-processed insulating materials, and the like. Further, as the ion conductive materials, e.g., perchlorates and chlorates of tetraethylammonium, lauryl trimethylammonium, alkaline metals such as lithium, alkaline earth metals, or magnesium, and the like, may be used.

As the solid lubricant, a layered material of fluorine resin such as PFA, PTFE, FEP (tetrafluoroethylene-hexafluoropropylene copolymer) and polyvinylidene fluoride (PVDF), molybdenum disulfide, tungsten disulfide, cadmium iodide, lead iodide, molybdenum diselenide, graphite, graphite fluoride, phthalocyanine, and the like, may be used.

Note that the shape of the pressure member 26 is not limited to the roller shape but may be a blade shape or a belt shape. In such cases, the member having the respective shapes can be formed using e.g. the above-described resin materials and rubber materials.

The intermediate transfer member 14 is supported with e.g. four support rollers 30, 32, 34 and 36. The first support roller 30 is provided at a right end of the intermediate transfer member 14. The second support roller 32 is provided at a left end of the intermediate transfer member 14. Further, the third support roller 34, provided at a lower end of the intermediate transfer member 14, is provided oppositely to the transfer roll 20 via the intermediate transfer member 14, with the intermediate transfer member 14 between the third support roller 34 and the transfer roll 20. The fourth support roller 36 is provided oppositely to the cleaning device 24 via the intermediate transfer member 14, with the intermediate transfer member 14 between the fourth support roller 36 and the cleaning device 24.

Note that in the present exemplary embodiment, the intermediate transfer member 14 is an endless belt; however, the intermediate transfer member 14 having a drum shape may be used in another exemplary embodiment.

The inkjet recording device 18 discharges liquid droplets (ink) to liquid absorbing particles transported with the intermediate transfer member 14. The inkjet recording device 18 has e.g. five recording heads 38, 40, 42, 44 and 46. The first to fourth recording heads 38, 40, 42 and 44 discharge ink. The first recording head 38, for black color, discharges ink including a black color material. The second recording head 40, for cyan color, discharges ink including a cyan color material. The third recording head 42, for magenta color, discharges ink including a magenta color material. The fourth recording head 44, for yellow color, discharges ink including a yellow color material. The fifth recording head 46, for a dampening solution, discharges a liquid to dampen the liquid absorbing particles. The liquid absorbing particles to which the inks have been applied are softened, and the adhesion thereof is increased. Since the fifth recording head 46 for the dampening solution is provided on the downstream side of the first to fourth recording heads 38, 40, 42 and 44 in an image forming direction, the dampening solution is discharged after ink discharge.

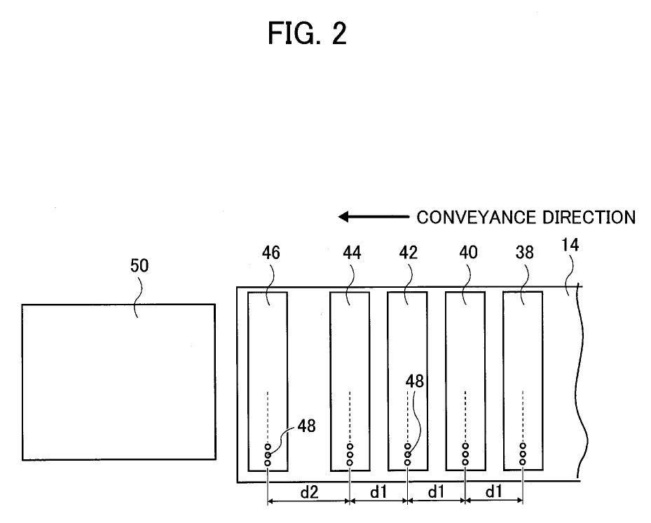

As shown in FIG. 2, the respective recording heads 38, 40, 42, 44 and 46 are e.g. full-line type heads and arrayed in a direction orthogonal to a transporting direction of the intermediate transfer member 14. In the respective recording heads 38, 40, 42, 44 and 46, a large number of discharge orifices 48 are formed so as to be opened toward the intermediate transfer member 14, at e.g. 1200 dpi (dot per inch) intervals along a lengthwise direction. The discharge orifices 48 are formed over a maximum width of a recording medium 50 on which an image formation is to be performed or a greater width. Further, driving elements (not shown) corresponding to the respective discharge orifices 48 are provided. The driving elements, which are piezoelectric elements or heater elements such as resistance elements, actuated in correspondence with an image signal or a non-image signal, to apply physical pressure or bubble-jet pressure to the inks, thus discharge the inks from the discharge orifices 48.

In the present exemplary embodiment, distances d1 between the discharge orifices 48 in the recording heads 38, 40, 42 and 44 (e.g., the distance between one discharge orifice 48 in the first recording head 38 and a corresponding discharge orifice 48 in a nozzle array direction in the second recording head 40) are equal. Further, a distance d2 between one discharge orifice 48 in the fourth recording head 44, provided on the most downstream side of the recording heads 38, 40 and 42 in the image forming direction, and a discharge orifice 48 in the fifth recording head 46 for the dampening solution is longer than the distance d1 between the discharge orifices 48 in the recording heads 38, 40, 42 and 44. As described later, the recording heads are arranged such that the inks discharged from the recording heads 38, 40, 42 and 44 sufficiently interpenetrate and spread among the liquid absorbing particles and then the dampening solution is discharged from the recording head 46 for the dampening solution.

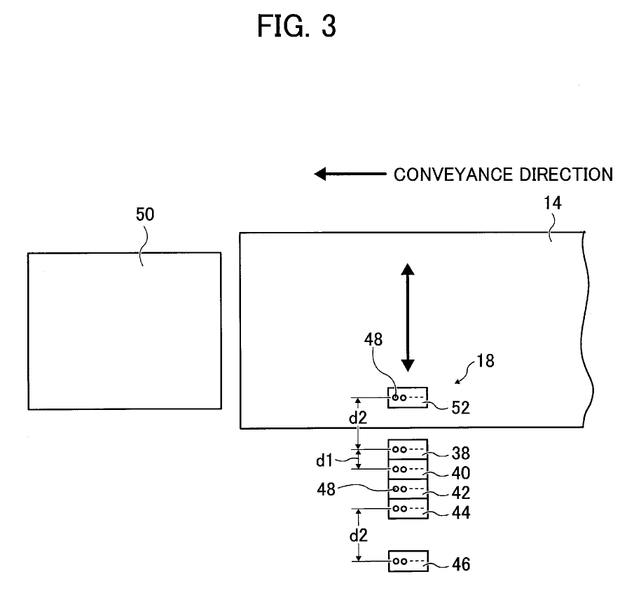

Note that in the present exemplary embodiment, the recording heads 38, 40, 42 and 44 are full-line type recording heads. However, as a modification as shown in FIG. 3, the recording heads 38, 40, 42 and 44 may be scan type recording heads. In this case, plural discharge orifices 48 are formed in the transporting direction of the intermediate transfer member 14, and the recording heads 38, 40, 42, 44 and 46, and a recording head 52 are arrayed in the direction orthogonal to the transporting direction of the intermediate transfer member 14. The recording heads 38, 40, 42, 44, 46 and 52 are reciprocate-scanned in the direction orthogonal to the transporting direction of the intermediate transfer member 14 to form an image. In this arrangement, the recording heads 46 and 52 provided on the both sides of the recording heads 38, 40 and 44 are recording heads for the dampening solution. When the recording heads 38, 40, 42, 44, 46 and 52 are scanned in one direction, the dampening solution is discharged from the recording head 46 provided on the downstream side in the scanning direction. On the other hand, when the recording heads 38, 40, 42, 46 and 52 are scanned in the other direction, the dampening solution is discharged from the recording head 52 provided on the downstream side in the scanning direction. In any scanning, the dampening solution is discharged after the ink discharge. In this modification, the distance d2 between one discharge orifice 48 in the first recording head 38 or the fourth recording head 44, provided on the most downstream side of the recording heads 38, 40, 42 and 44 in the image forming direction and the discharge orifice 48 in the fifth recording head 46 or the sixth recording head 52 for the dampening solution is longer than the distance d1 between the discharge orifices 48 in the recording heads 38, 40, 42 and 44.

The transfer roll 20 is formed by e.g. coating the outer peripheral surface of a metal core with an elastic body such as silicone rubber and coating the outer peripheral surface of the elastic body with a non-viscous material such as PFA (Tetrafluoroethylen-perfluoroalkylvinylether copolymer). The recording medium 50 is supplied from a recording medium supply part 54, and transported between the intermediate transfer member 14 and the transfer roll 20. A pressing force (e.g. 0.5 MPa) by a pressing member 55 such as a spring acts between the transfer roll 20 and the third support roller 34. The liquid absorbing particles, to which the inks have been applied by the inkjet recording device 18, are squashed between the intermediate transfer member 14 and transfer roll 20, thereby the liquid absorbing particles are transferred to the transported recording medium 50.

Note that it may be arranged such that the transfer roll 20 is a heat roller to apply heat to the liquid absorbing particles to thereby transfer the liquid absorbing particles.

As the softened liquid absorbing particles are transferred onto the recording medium 50, the recording medium 50 may be a permeable medium (e.g., plain paper or inkjet coated paper) or a non-permeable medium (e.g., art paper or a resin film). Further, print-transfer can be made to a rough recording medium.

The fixing device 22 has a heating roller 56 provided on the image recording side and a pressure roller 58 provided on the non image-recording side. The heating roller 56 includes a heater 60 as a heat source inside. The heating roller 56 and the pressure roller 58 are respectively formed by e.g. coating the outer peripheral surface of a metal core with an elastic body such as silicone rubber and coating the outer peripheral surface of the elastic body with a non-viscous material such as PFA. The heating roller 56 and the pressure roller 58, in contact with each other with a pressing force, rotate in a transporting direction of the recording medium 50. When the recording medium 50 is passed between the heating roller 56 and the pressure roller 58, the liquid absorbing particles are fixed to the recording medium 50 by heat and pressure. In the fixing device 22, the surface temperature of the heating roller 56 is 100° C. or lower, e.g., 95° C. The heating roller 56 and the pressure roller 58 are pressurized at e.g. 0.5 MPa and rotated at a peripheral velocity of 100 mm/s.

The cleaning device 24, provided in the intermediate transfer member 14 on the downstream side of the transfer roll 20, removes liquid absorbing particles and other foreign materials (e.g. paper dust of recording medium) remaining on the intermediate transfer member 14. The cleaning device 24, supporting e.g. a blade, brings the end of the blade into contact with the intermediate transfer member 14, thereby scrapes off the liquid absorbing particles and other foreign materials attached to the intermediate transfer member 14.

Next, the liquid absorbing particle will be described.

The liquid absorbing particle has ink recipience to receive an ink component upon contact with the ink. Note that the ink recipience means a characteristic of holding at least some of ink components (at least a liquid component). The liquid absorbing particle includes e.g. at least an organic resin in which the percentage of a polar monomer having a polar group with respect to the entire monomer component is 10 mol % to 90 mol %. More particularly, the liquid absorbing particles have a particle including e.g. the above organic resin (hereinbelow, referred to as a “hydrophilic organic particle”) (hereinbelow, the particle including the hydrophilic organic particle will be referred to as a “mother particle”).

Note that the hydrophilic liquid absorbing particle includes at least an organic resin having the percentage of polar monomer with respect to the entire monomer component of 10 mol % to 90 mol %. This liquid absorbing particle has a higher adhesion in comparison with a hydrophobic liquid absorbing particle.

The liquid absorbing particle may have a structure in which a mother particle is a single hydrophilic organic particle (primary particle) or may have a structure in which a mother particle is a composite particle formed with a group of hydrophilic organic particles.

Note that in the case where the mother particle is a single hydrophilic organic particle (primary particle), when the liquid absorbing particle receives ink and the ink is attached to the liquid absorbing particle, at least the liquid component of the ink is absorbed with the hydrophilic organic particle.

In this manner, the liquid absorbing particle receives ink. Then, the liquid absorbing particle that received ink is transferred onto a recording medium, thereby recording is performed.

On the other hand, in the case where the mother particle is a composite particle formed with a group of at least hydrophilic organic particles, when the liquid absorbing particle receives ink and the ink is attached to the liquid absorbing particle, at least a liquid component of the ink is trapped with a void among the particles (at least hydrophilic organic particles) forming the composite particle (hereinbelow, the void among the particles may be referred to as a “trap structure”). At this time, a recording material among the ink components is attached to the surface of the liquid absorbing particle or trapped with the trap structure. In this manner, the liquid absorbing particle receives the ink. Then the liquid absorbing particle that has received ink is transferred onto a recording medium, thereby recording is performed.

The trapping of ink liquid component with the trap structure is physical and/or chemical trapping with a void among the particles (physical particle wall structure).

When the structure in which the mother particle is a composite particle of a group of at least hydrophilic organic particles is employed, an ink liquid component is absorbed and held with the hydrophilic organic particles in addition to trapping with an airspace among the particles forming the composite particle (physical particle wall structure).

Note that the “airspace among the particles forming the composite particle”, namely, “the trap structure” is a physical particle wall structure which can trap at least a liquid. As the size of the airspace, the maximum aperture may be 0.1 μm to 5 μm.

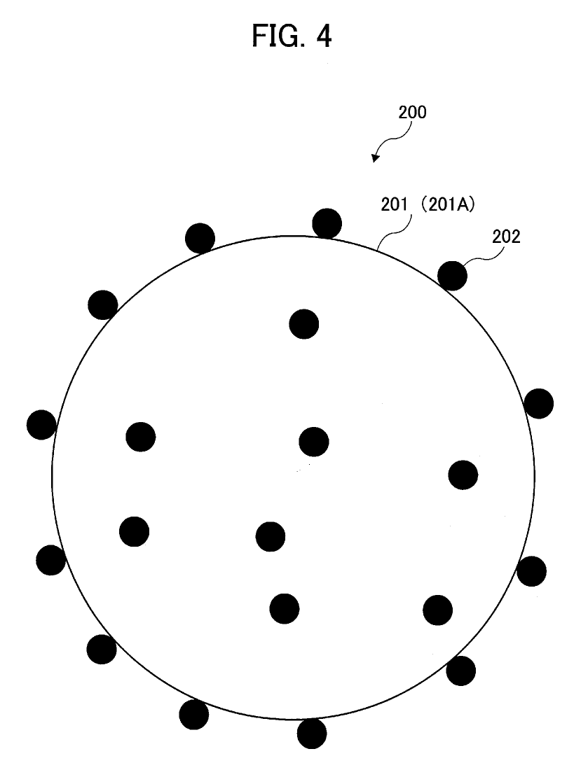

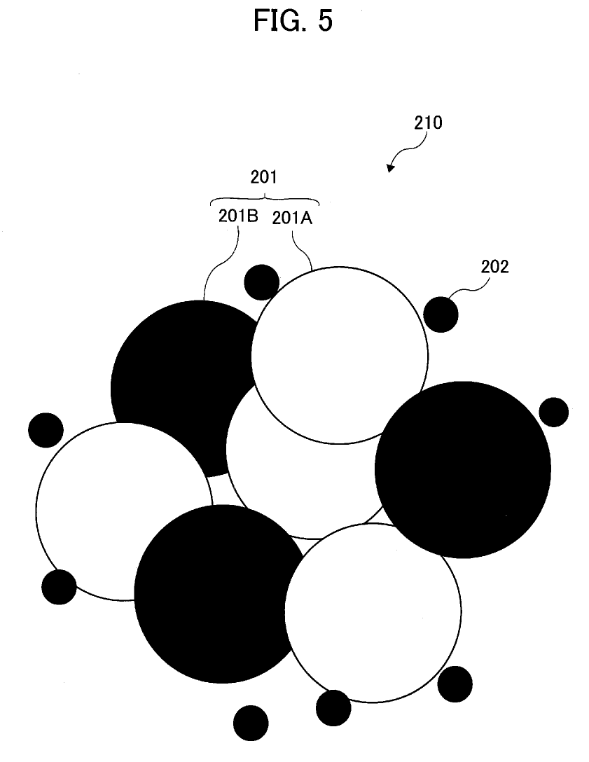

As a particular structure of the liquid absorbing particle, e.g. FIG. 4 shows a liquid absorbing particle 200 having a mother particle 201 as a single hydrophilic organic particle 201A (primary particle) and inorganic particles 202 attached to the mother particle 201. Further, FIG. 5 shows a liquid absorbing particle 210 having a mother particle 201 as a composite particle formed with hydrophilic organic particles 201A and inorganic particles 201B, and the inorganic particles 202 attached to the mother particle 201. Note that in the mother particle of as a composite particle, an airspace structure is formed with airspaces among the respective particles.

Further, the average equivalent spherical particle diameter of the mother particle may be in the range of 0.1 μm to 50 μm.

Further, when the mother particle is a composite particle, its BET specific surface area (N₂) is 1 m²/g to 750 m²/g.

Next, the hydrophilic organic particle will be described. The hydrophilic organic particle includes an organic resin in which the percentage of a polar monomer with respect to the entire monomer component is 10 mol % to 90 mol %. More particularly, the hydrophilic organic particle may include an organic resin with the above-described polar monomer percentage (hereinbelow, referred to as a “water absorbing resin”).

Note that the polar monomer is a monomer including a polar group such as an ethylene oxide group, a carboxylic acid group, a sulfonic acid group, a substituent or non-substituent amino group, a hydroxide group, an ammonium group, and these salts. For example, upon application of positive electrostatic property, the polar monomer may be a monomer having a salt-forming structure including e.g. a (substituent) amino group, an ammonium group, a (substituent) pyridine group or its amine salt, a quarternary ammonium salt or the like. Upon application of negative electrostatic property, the polar monomer may be a monomer having an organic acid (salt) structure such as a carboxylic acid (salt) or a sulfonic acid (salt).

Note that the percentage of a polar monomer is obtained as follows. First, the composition of organic component is specified by an analysis method such as mass spectrometry, NMR or IR. Then, acid value and hydroxyl value of the organic component are measured in conformity with JIS K0070 or JIS K 2501. In this manner, the percentage of the polar monomer can be calculated from the composition of the organic component and the acid value/hydroxyl value. The percentage of a polar monomer in the hydrophobic organic particle can be similarly obtained.

As a hydrophobic monomer, a monomer having a hydrophobic group can be used. More particularly, e.g. olefin (ethylene, butadiene or the like), styrene, α-methyl styrene, α-ethyl styrene, methyl methacrylate, ethyl methacrylate, butyl methacrylate, acrylonitrile, vinyl acetate, methyl acrylate, ethyl acrylate, butyl acrylate, lauryl methacrylate and the like may be used. As a hydrophobic unit or monomer, styrene derivatives such as styrene, α-methyl styrene and vinyltoluene, vinylcyclohexene, vinylnaphthalene, a vinylnaphthalene derivative, alkyl acrylate, phenyl acrylate, alkyl methacrylate, phenyl methacrylate, cyclo alkyl methacrylate, alkyl crotonate, di-alkyl itaconate, di-alkyl maleate and the like and derivatives thereof may be used.

As a liquid absorbing resin which is a copolymer of the hydrophilic monomer and hydrophobic monomer, particularly e.g., (meth)acrylic acid/(meth)acrylate, styrene/(meth)acrylic acid/(anhydrous)maleic acid copolymers, olefin polymers such as ethylene/propylene (otherwise modified material thereof, or carboxylic acid unit containing material by copolymerization), branched polyester in which the acid number is improved with trimellitic acid or the like, polyamide and the like, may be used.

The liquid absorbing resin includes e.g. a neutralization salt structure (such as carboxylic acid). When the neutralization salt structure such as carboxylic acid absorbs ink including cation (e.g. univalent metal cation such as Na or Li), the structure forms ionomer by mutual action with the cation.

The liquid absorbing resin may include a substituent or non-substituent amino group, a substituent or non-substituent pyridine group or the like. The group causes mutual action with recording material having an anion group (e.g. a pigment or dye).

Note that in the liquid absorbing resin, the mole ratio between a hydrophilic unit (hydrophilic monomer) and a hydrophobic unit (hydrophobic monomer), (hydrophilic monomer:hydrophobic monomer), is e.g. 5:95 to 70:30.

Further, the liquid absorbing resin may be ion-bridged with ions supplied from ink.

The liquid absorbing resin may be an amorphous resin. The glass-transition temperature (Tg) of the liquid absorbing resin is e.g. 40° C. to 90° C. The glass-transition temperature is obtained from a major maximum peak measured in accordance with ASTMD 3418-8. The measurement of the major maximum peak can be made using DSC-7 manufactured by PerkinElmer, Inc. In the apparatus, temperature correction in a detection part is performed using a melting point of indium and zinc, and the calorimetric value correction is performed using fusion heat of indium. As a sample, an aluminum pan is used, while an empty pan is set as a control sample, and measurement is performed at temperature elevation rate of 10° C./min.

The weight average molecular weight of the liquid absorbing resin is e.g. 3,000 to 300,000. The weight average molecular weight is measured under the following conditions. For example, as a GPC, “HLC-8120GPC, SC-8020 (liquid chromatography system manufactured by Tosoh Corporation)” is used, two columns “TSK gel, Super HM-H (6.0 mmID×15 cm, manufactured by Tosoh Corporation)” are used, and as a eluting solution, THF (tetrahydrofuran) is used. As experimental conditions, an experiment is performed using an IR detector, with a sample density of 0.5%, a flow rate of 0.6 ml/min, a sample injection amount of 10 μl, and at a measurement temperature of 40° C. Further, the analytical curve is made from 10 samples of “polystylene standard sample TSK standard” manufactured by Tosoh Corporation: “A-500”, “F-1”, “F-10”, “F-80”, “F-380”, “A-2500”, “F-4”, “F-40”, “F-128” and “F-700”.

As the acid number of the liquid absorbing resin, e.g. a expressed acid value of carboxylic acid groups (—COOH) is 50 mgKOH/g to 777 mgKOH/g. The measurement of the acid value of carboxylic acid groups (—COOH) is performed in conformity with JIS K0070 using neutralization titration.

The above-described liquid absorbing resin, in any form, is used with its polar monomer percentage controlled within the above range.

Regarding the particle diameter of the hydrophilic organic particle, when its primary particle is a mother particle, the average equivalent spherical particle diameter is, for example, 0.1 μm to 50 μm. On the other hand, when the mother particle is a composite particle, the average equivalent spherical particle diameter is, for example, 10 nm to 30 μm.

Next, the inorganic particle forming the composite particle together with the hydrophilic organic particle, and the inorganic particle attached to the mother particle will be described. As an inorganic particle, both non-porous particle and porous particle can be used. As an inorganic particle, achromatic, pale or white particle (e.g., colloidal silica, alumina, calcium carbonate, zinc oxide, titanium oxide and tin oxide) may be used. These inorganic particles may be subjected to surface treatment (partial water repellent treatment, specific functional group modifying process or the like). For example, when silica is used, hydroxyl group of silica is processed with a silylation agent such as trimethylchlorosilane and t-butyl-dimethylchlorosilane thereby an alkyl group is bonded. The silylation agent causes dehydrochlorination and promotes a reaction. At this time, when amine is added, the reaction can also be promoted by changing the hydrochloric acid to hydrochloride. Such control can be performed by controlling the process amount and/or process condition of the coupling agent such as a silane coupling agent having an alkyl group or phenyl group as a hydrophobic radical, a titanate coupling agent or a zirconate coupling agent. Further, surface treatment using aliphatic alcohols, higher fatty acid and derivatives thereof can be performed. Further, surface treatment using a coupling agent having a cationic functional group such as a silane coupling agent having a (substituent) amino group or a quaternary ammonium salt structure, a coupling agent having a fluorinated functional group such as fluoroalkylsilane, and a coupling agent having an anion functional group such as carboxylic acid, can be performed. Note that these inorganic particles may be included in the hydrophilic organic particles.

Further, as the particle diameter of the inorganic particle forming the composite particle, for example, an average equivalent spherical particle diameter is 10 nm to 30 μm. On the other hand, as the particle diameter of the inorganic particle attached to the mother particle, for example, an average equivalent spherical particle diameter is 10 nm to 1 μm.

Next, the other additive in the liquid absorbing particle will be described. The liquid absorbing particle may contain a coagulating agent such as an inorganic electrolyte, organic acid, inorganic acid or organic amine to coagulate or viscosity-body the ink component.

As the inorganic electrolyte, an alkali metal ion such as a lithium ion, a sodium ion and a potassium ion, a polyvalent metal ion such as an aluminium ion, a barium ion, a calcium ion, a copper ion, an iron ion, a magnesium ion, a manganese ion, a nickel ion, a tin ion, a titanium ion, a zinc ion and the like can be used. As the inorganic acid, hydrochloric acid, boromic acid, hydriodic acid, sulfuric acid, nitric acid, phosphoric acid, thiocyanic acid and the like can be used. As the organic acid, organic carboxylic acid such as acetic acid, oxalic acid, lactic acid, fumaric acid, citric acid, salicylic acid, benzoic acid, and salts of organic sulfonic acid, may be used.

As an organic amine compound, any of primary, secondary, thertiary and quarternary amines and salts thereof may be used. As particular examples, triethanolamine, tri-isopropanol amine, 2-amino-2-ethyl-1,3-propanediol, ethanolamine, propane diamine, propyl amine and the like can be used.

Among these coagulating agents, polyvalent metal salts (Ca(NO₃)₂, Mg(NO₃)₂, Al(OH)₃, poly aluminum chloride and the like) may be used.

The coagulating agent may be used as a agent or mixed two or more types of agents may be used. Further, when the content of the coagulating agent in the liquid absorbing particle is 0.01% to 30% by mass, the coagulating agent may include a releasing agent. The releasing agent maybe included in the above-described liquid absorptive resin; otherwise, particles of releasing agent may be composed with hydrophilic organic resin particles and included in the liquid absorbing particles.

Examples of the releasing agent include low molecular polyolefins such as polyethylene, polypropylene and polybutene; silicones having a softening point caused by heating; fatty acid amides such as oleic amide, erucic amide, ricinoleic amide and stearic amide; vegetable waxes such as carnauba wax, rice wax, candelilla wax, Japan wax and jojoba oil; animal waxes such as beeswax; mineral or petroleum waxes such as montan wax, ozokerite, ceresin, paraffin wax, microcrystalline wax and Fischer-Tropsch wax; and modifications thereof. Among these, crystalline compounds may be used.

As the ink in the exemplary embodiment, water-color ink is used. The water-color ink (hereinbelow, simply referred to as “ink”) includes an ink solvent (e.g., water or a water soluble organic solvent) in addition to a recording material. Further, the ink may include other additives in accordance with necessity.

First, the recording material will be described. As the recording material, color material is given. As a color material, dyes and pigments can be used, however, pigments are appropriate. As pigments, organic pigments and inorganic pigments can be used. As a black pigment, carbon black pigments such as furnace black, lamp black, acetylene black and channel black may be used. In addition to pigments of black and three primary colors i.e. cyan, magenta and yellow, pigments of particular colors i.e. red, green, blue, brown and white, metal glossy pigments of gold, silver and the like, further, colorless or pale-color extender pigments, plastic pigments, and the like, may be used. Further, newly synthesized pigments for the present invention may be used.

Further, particles formed by attaching a dye or pigment to the surface of a bead of silica, alumina, polymer or the like as a core, further, dye insoluble lakes, colored emulsions, colored latex and the like, may be used as the pigments.

As particular examples of the black pigment, RAVEN 7000 (manufactured by Columbian Chemicals Co.), REGAL 400R (manufactured by Cabot Corp.), COLOR BLACK FW1 (manufactured by Degussa Co.) and the like may be used, however, the black pigment is not limited to these pigments.

As particular examples of the cyan pigment, C.I. Pigment Blue-1, C.I. Pigment Blue-2, C.I. Pigment Blue-3, C.I. Pigment Blue-15, C.I. Pigment Blue-15:1, C.I. Pigment Blue-15:2, C.I. Pigment Blue-15:3, C.I. Pigment Blue-15:4, C.I. Pigment Blue-16, C.I. Pigment Blue-22, C.I. Pigment Blue-60 and the like may be used, however, the cyan pigment is not limited to these pigments.

As particular examples of the magenta pigment, C.I. Pigment Red-5, C.I. Pigment Red-7, C.I. Pigment Red-12, C.I. Pigment Red-48, C.I. Pigment Red-48:1, C.I. Pigment Red-57, C.I. Pigment Red-112, C.I. Pigment Red-122, C.I. Pigment Red-123, C.I. Pigment Red-146, C.I. Pigment Red-168, C.I. Pigment Red-177, C.I. Pigment Red-184, C.I. Pigment Red-202, C.I. Pigment Violet-19 and the like may be used, however, the magenta pigment is not limited to these pigments.

As particular examples of the yellow pigment, C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-138, C.I. Pigment Yellow-151, C.I. Pigment Yellow-154, C.I. Pigment Yellow-180 and the like may be used, however, the yellow pigment is not limited to these pigments.

Note that when pigments are used as color materials, pigment dispersants may also used. As a usable pigment dispersant, a polymer dispersant, an anionic surfactant, a cationic surfactant, an amphoteric surfactant, a nonionic surfactant and the like may be used.

As the polymer dispersant, a polymer having a hydrophilic structural unit and a hydrophobic structural unit may be used. As such polymer having a hydrophilic structural unitt and a hydrophobic structural unit, a condensation polymer and an addition polymer can be used. As the condensation polymer, a publicly-known polyester dispersant may be used. As the addition polymer, a monomer addition polymer having an α,β-ethylene unsaturated group may be used. A desired polymer dispersant can be obtained by copolymerizing a monomer having an α,β-ethylene unsaturated group having a hydrophilic group with a monomer having an α,β-ethylene unsaturated group having a hydrophobic group. Further, a monomer having an α,β-ethylene unsaturated group having a hydrophilic group as a homopolymer can be used.

As examples of a copolymer used as a polymer dispersant, a styrene-styrenesulfonic acid copolymer, a styrene-maleic acid copolymer, a styrene-methacrylic acid copolymer, a styrene-acrylic acid copolymer, a vinylnaphthalene-maleic acid copolymer, a vinylnaphthalene-methacrylic acid copolymer, a vinylnaphthalene-acrylic acid copolymer, an alkyl acrylate-acrylic acid copolymer, an alkyl methacrylate-methacrylic acid copolymer, a styrene-alkyl methacrylate-methacrylic acid copolymer, a styrene-alkyl acrylate-acrylic acid copolymer, a styrene-phenyl methacrylate-methacrylic acid copolymer, a styrene-cyclohexyl methacrylate-methacrylic acid copolymer, and the like, may be used. Further, these polymers may be copolymerized with a monomer having a polyoxyethylene group or a hydroxyl group.

As the above-described polymer dispersant, dispersants having, for example, 2000 to 5000 of weight average molecular weight may be used.

These pigment dispersants may be used as a single dispersant or as a mixture of two or more dispersants. Although the amount of addition of the pigment dispersant greatly differs in accordance with pigment, generally 0.1% to 100% by mass to a pigment may be used.

Further, a pigment which is water self-dispersible can be used as a color material. The water self-dispersible pigment, having a large number of solubilization groups to water on the pigment surface, disperses in water without polymer dispersant. More particularly, such water self-dispersible pigment can be obtained by performing surface modification treatments such as acid/base treatment, coupling agent treatment, polymer graft treatment, plasma treatment and oxidation/reduction treatment, on a general so-called pigment.

Further, as the water self-dispersible pigments, in addition to the above-described pigments subjected to the surface modification treatment, commercially available self-dispersible pigments CAB-O-JET-200, CAB-O-JET-300, IJX-157, IJX-253, IJX-266, IJX-273, IJX-444, IJX-55 and CAB-O-JET-260 (manufactured by Cabot Corporation), MICROJET BLACK CW-1 and MICROJET BLACK CW-2 (manufactured by Orient Chemical Industries, Ltd.) and the like can be used.

The self-dispersible pigment may be a pigment having at least sulfonic acid, sulfonate, carboxylic acid or carboxylate salt as a functional group in its surface. The self-dispersible pigment may be a pigment having at least carboxylic acid or carboxylate salt as a functional group in its surface.

Further, resin-coated pigments and the like can be used. As such pigment, called a microcapsule pigment, in addition to commercially-available microcapsule pigments manufactured by DIC Corporation, Toyo Ink MFG. Co., Ltd., and the like, microcapsule pigments pre-manufactured for the present invention can be used.

Further, resin contained pigments in which polymer is physically adsorbed to or chemically combined with the above-described pigments can be used.

As further recording materials, dyes such as a hydrophilic anion dye, a direct dye, a cation dye, a reactive dye, a high polymer dye and the like, oil soluble dyes and the like, dye-colored wax powder, resin powder and emulsions, fluorescence dyes and fluorescence pigments, infrared ray absorbers, ultraviolet absorbers, magnetic bodies such as ferromagnetic materials represented by ferrite or magnetite, semiconductors represented by titanium oxide or zinc oxide, photocatalysts, other organic and inorganic electronic material particles, may be used.

The content (concentration) of the recording material is, for example, from 5% to 30% by mass with respect to the amount of the ink.

The volume average particle diameter of the recording material is, for example, from 10 nm to 1000 nm.

The volume average particle diameter of the recording material is a particle diameter of the recording material itself, otherwise, when an additive such as a dispersant is attached to the recording material, the particle diameter of the recording material to which the additive is attached. As a device to measure the volume average particle diameter, a MICROTRUC UPA size analyzer 9340 (manufactured by Leeds & Northrup) is used. The measurement is carried out according to the predetermined method with 4 ml of an ink put into a measuring cell. Note that as input values upon measurement, ink viscosity is inputted as viscosity, and the density of dispersed particles is inputted as the density of the recording material.

Next, the water soluble organic solvents will be described. As such water soluble organic solvents, polyhydric alcohols, polyhydric alcohol derivatives, nitrogen-containing solvents, alcohols, sulfur-containing solvents and the like are used.

As particular examples of the water soluble organic solvent, in the polyhydric alcohols such as ethylene glycol, diethylene glycol, and propylene glycol, and sugars alcohols such as xylose, glucose and galactose, may be used.

As the polyhydric alcohol derivatives, ethylene glycol monomethylether, ethylene glycol monoethyl ether, ethylene glycol monobutylether and the like, may be used.

As the nitrogen-containing solvents, pyrrolidone, N-methyl-2-pyrrolidone, cyclohexyl pyrrolidone, triethanolamine and the like, and as the alcohols, ethanol, isopropyl alcohol, butyl alcohol, benzyl alcohol and the like, may be used.

As the sulfur-containing solvents, thiodiethanol, thiodiglycerol, sulfolane, dimethyl sulfoxide and the like, may be used.

As other water soluble organic solvents, a propylene carbonate, an ethylene carbonate and the like can be used.

At least one type of the water soluble organic solvents may be used. As the content of the water soluble organic solvent, for example, from 1% to 70% by mass may be used.

Next, the water used in dampening solution or ink will be described. As the water, especially to prevent contamination with impurities, ion exchanged water, extra pure water, distilled water or ultrafiltered water may be used.

Next, the other additives will be described. A surfactant can be added to the ink.

As the types of the surfactants, various types of anion surfactants, nonionic surfactants, cationic surfactants, amphoteric surfactants and the like may be used. An anionic surfactant or nonionic surfactant may be better used. Specific examples of the anionic surfactants include an alkylbenzene sulfonate, alkylphenyl sulfonate, alkylnaphthalene sulfonate, higher fatty acid salt, sulfuric acid ester salt of higher fatty acid ester, sulfonic acid salt of higher fatty acid ester, sulfuric acid ester salt and sulfonic acid salt of higher alcohol ether, higher alkylsulfosuccinate, polyoxyethylene alkylethercarboxylate, polyoxyethylene alkylethersulfate, alkylphosphate and polyoxyethylene alkyletherphosphate, and dodecylbenzene sulfonate, isopropylnaphthalene sulfonate, monobutylphenylphenol monosulfonate, monobutylbiphenyl sulfonate, monobutylbiphenyl sulfonate and dibutylphenylphenoldisulfonate may be used.

Specific examples of the nonionic surfactants include polyoxyethylene alkyl ether, polyoxyethylene alkylphenyl ether, polyoxyethylene fatty acid ester, sorbitan fatty acid ester, polyoxyethylene sorbitan fatty acid ester, polyoxyethylene sorbitol fatty acid ester, glycerol fatty acid ester, polyoxyethyleneglycerol fatty acid ester, polyglycerol fatty acid ester, sucrose fatty acid ester, polyoxyethylene alkylamine, polyoxyethylene fatty acid amide, alkylalkanol amide, polyethyleneglycol polypropyleneglycol block copolymer, acetylene glycol and polyoxyethylene adduct of acetylene glycol, and polyoxyethylene nonyl phenyl ether, polyoxyethylene octyl phenyl ether, polyoxyethylene dodecyl phenyl ether, polyoxyethylene alkyl ether, polyoxyethylene fatty acid ester, sorbitan fatty acid ester, polyoxyethylene sorbitan fatty acid ester, fatty acid alkylol amide, polyethyleneglycol polypropyleneglycol block copolymer, acetylene glycol and polyoxyethylene adduct of acetylene glycol may be used.

These surfactants may be used alone, or in combination. Further, the hydrophile-lipophile balance (HLB) of the surfactant may be in the range of 3 to 20 in consideration of solubility or the like.

The amount of addition of the surfactant is desirably 0.001% to 5% by mass, or more desirably 0.01% to 3% by mass.

Further, other various additives may be added to the ink, such as a permeating agent for adjusting permeating property of the ink, compounds such as polyethylene imine, polyamines, polyvinyl pyrrolidone, polyethylene glycol, ethyl cellulose and carboxy methyl cellulose, for controlling ink ejection property, and alkali metal compounds such as potassium hydroxide, sodium hydroxide and lithium hydroxide for adjusting conductivity and pH of the ink. As needed, a pH buffer, an antioxidant, a mildew preventing agent, a viscosity adjusting agent, a conductive agent, an ultraviolet ray absorbing agent, a chelating agent or the like may also be added.

Next, properties of the ink will be described. First, the surface tension of the ink is 20 mN/m to 45 mN/m.

Note that as the surface tension, a value measured by using a Wilhelmy surface tensiometer (produced by Kyowa Interface Science Co., Ltd.) in an environment at 23° C. and 55% RH is used.

The viscosity of the ink is 1.5 mPa·s to 30 mPa·s.

Note that as the viscosity, a value obtained by measurement using a measuring apparatus, RHEOMAT 115 (manufactured by Contraves) at a measurement temperature of 23° C. and a shearing speed of 1400 s⁻¹ is used.

Note that the ink is not limited to the above-described composition. For example, in addition to the recording material, the ink may contain functional materials such as liquid crystal materials or electronic materials.

The dampening solution will be described. As properties required of a dampening solution, it may be colored to an inconspicuous level, but colorless and transparent as much as possible, and has a property to produce the adhesibility of the liquid absorbing particles to the same degree of or higher degree than that of other inks. The property to further produce the adhesivibility means that the amount of liquid droplets necessary to produce the same adhesivibility strength is smaller.

Further, the dampening solution may be water, however, in consideration of ejection of liquid droplets from the ejecting prat, physical property values such as viscosity and surface tension may be close to those of ink.

Further, the purpose of the present invention intends to increase a dot size. For example, a combination, which causes a reaction between ink and the dampening solution and disturbs ink penetration (spread) in accordance with discharge interval, is not appropriate. An appropriate combination is e.g., a combination which stably disperses a color material even when the ink and the dampening solution are mixed by equivalent amount.

From the above-described ground, the dampening solution in the present exemplary embodiment is obtained to except the color material from the ink.

As an example of the inks and dampening solution, Table 1 shows a case using water soluble pigment inks.

TABLE

| | | | | | Dampening |
|---|---|---|---|---|---|
| Ink | Black | Cyan | Magenta | Yellow | solution |
| Bonjet Black | 5% | 0% | 0% | 0% | 0% |
| CW-2 (by | | | | | |
| Orient Chemical | | | | | |
| Industries, Ltd.) | | | | | |
| C.I. Pigment | 0% | 5% | 0% | 0% | 0% |
| Blue 15:3 | | | | | |
| C.I. Pigment | 0% | 0% | 5% | 0% | 0% |
| Red 122 | | | | | |
| C.I. Pigment | 0% | 0% | 0% | 5% | 0% |
| Yellow 74 | | | | | |
| glycerine | 10% | 10% | 10% | 10% | 10% |
| Olfine E1010 (by | 1% | 1% | 1% | 1% | 1% |
| Nissin Chemical | | | | | |
| Industry Co., Ltd) | | | | | |
| styrene- | 0% | 1% | 1% | 1% | 0% |
| methacrylate | | | | | |
| copolymer | | | | | |
| (molecular | | | | | |
| weight 8400) | | | | | |
| water | remnant | remnant | Remnant | remnant | remnant |

As described above, in the present exemplary embodiment, the ink is discharged to the layer of liquid absorbing particles and then the dampening solution is discharged. This order is determined based on the discovery of difference in dot ink size due to the discharge order by the present inventors. The significance of the order will be described in the following two cases.

### [Total 100% Droplet Discharge]

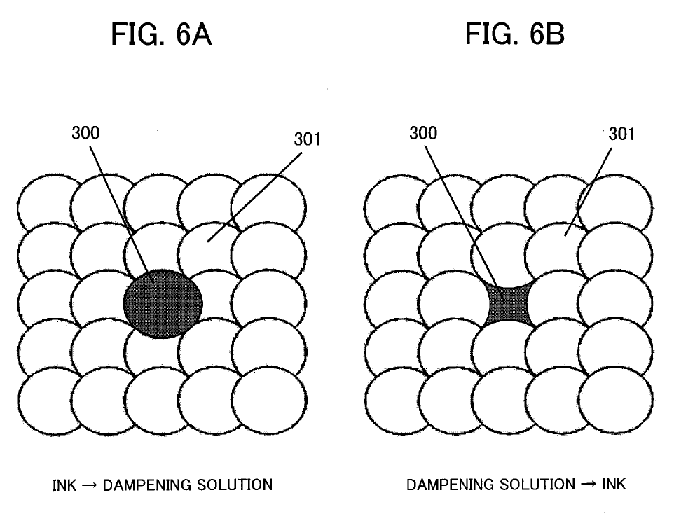

FIGS. 6A and 6B schematically show the case where the amount of droplet discharge is total 100%. FIG. 6A shows a state in which ink 300 is discharged and then a dampening solution 301 is discharged as in the case of the present exemplary embodiment. FIG. 6B is a conceptual diagram as a comparative example showing a state in which the dampening solution 301 is discharged and then the ink 300 is discharged. The ink amount or the amount of the dampening solution in each dot is total 100%, and discharge with a maximum ink droplet diameter from the recording head is the reference of 100% discharge in single color solid recording. A region to which the ink is discharged is an image region where an image is formed. A region to which the dampening solution is discharged is a non-image region where an image is not formed. In this manner, when the ink is exclusively discharged in all the dots in the image region and the non-image region with approximately uniform ink application amount, a stable state can be maintained and transfer failure can be prevented. On the other hand, when the percentage of the ink in the particles is non-uniform, the liquid absorbing particle in a portion where the amount of the ink is small has a low adhesive strength, while the liquid absorbing particle in a portion where the amount of the ink is large has a low coagulating force and is separated, i.e., in any case, transfer failure easily occurs.

It is considered that when the ink 300 is discharged first as shown in FIG. 6A, the interference by the dampening solution 301 does not occur in an ink spreading direction. The ink 300 can freely spread. On the other hand, it is considered that when the dampening solution 301 is discharged and then the ink 300 is discharged as shown in FIG. 6B, the ink 300 is prevented with the peripheral dampening solution 301 from spreading. Accordingly, it is considered that the dot size of the ink when the ink is first discharged is larger than that when the ink is discharged later.

In this manner, when the liquid droplet amount is total 100%, it is necessary in halftone representation to set the total liquid droplet amount in each dot to 100% (e.g., the ink 300 is 30%, and the dampening solution 301, 70%). When the dampening solution 301 is discharged and then the ink 300 is discharged, as the ink 300 does not spread, the optical density is low. However, when the ink 300 is first discharged, as the ink 300 spreads, the optical density is high.

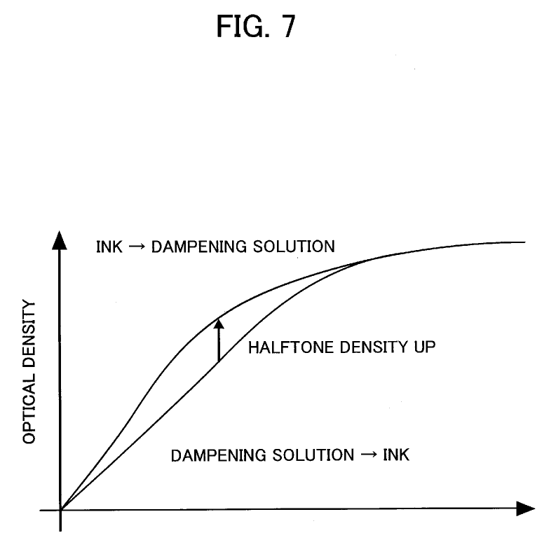

FIG. 7 is a line chart showing a comparison of variation of optical density with respect to ink droplet discharge amount between the case where the ink is discharged and then the dampening solution is discharged and the case where the dampening solution is discharged and then the ink is discharged. When the ink is discharged and then the dampening solution is discharged, the optical density in halftone representation can be higher in comparison with the case where the dampening solution is discharged and then the ink is discharged.

### [Total 200% Droplet Discharge]

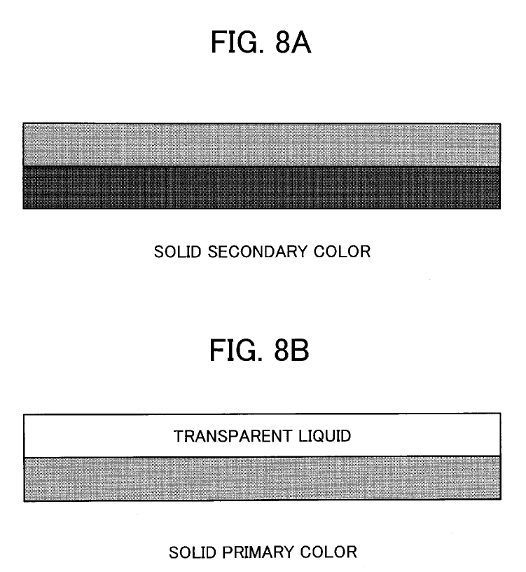

FIGS. 8A and 8B are conceptual diagrams in the case where the amount of droplet discharge is total 200%. In solid secondary color recording, respectively 100% ink and dampening solution are discharged. For example, FIG. 8A is a conceptual diagram showing a solid secondary color recording with the amount of e.g. cyan 100% and magenta 100% droplet discharge, i.e., total 200% droplet discharge. FIG. 8B is a conceptual diagram showing a solid primary color recording with the amount of e.g. cyan 100% and the dampening solution 100% droplet discharge, i.e. total 200% droplet discharge. In a non-image region, 200% dampening solution is discharged. To achieve the above, discharge is performed twice with a recording head for the dampening solution, or the dampening solution is discharged with two recording heads for the dampening solution to one dot.

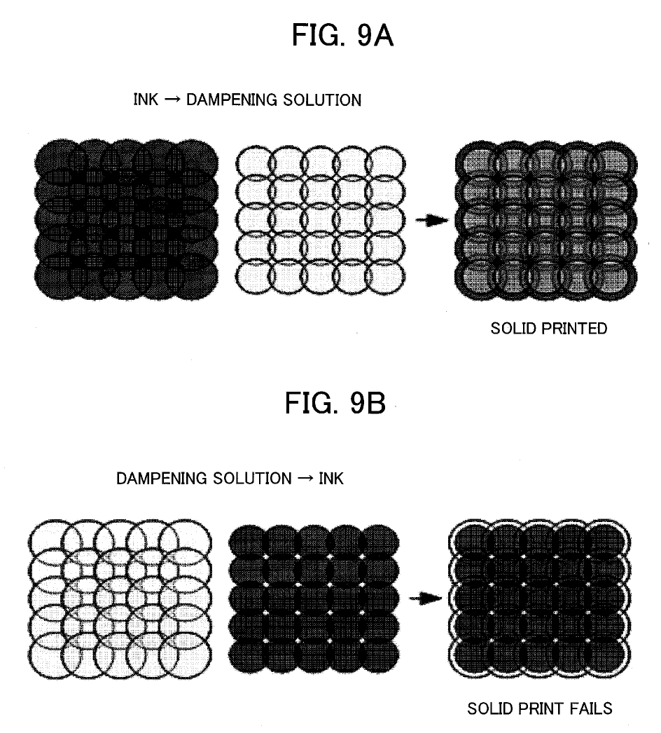

FIG. 9A shows the case where the ink is discharged and then the dampening solution is discharged for formation of a single color solid image with a predetermined liquid droplet amount, and FIG. 9B shows the case where the dampening solution is discharged and then the ink is discharged for formation of a single color solid image with the same amount as the liquid droplet amount in FIG. 9A.

When the ink is discharged and then the dampening solution is discharged, since the ink in respective dots spreads at the stage of ink discharge, solid recording is made among the respective dots without gap. On the other hand, when the dampening solution is discharged and then the ink is discharged, since the ink in the respective dots are prevented with the dampening solution from spreading, gaps occur among the respective dots and solid recording cannot be completed.

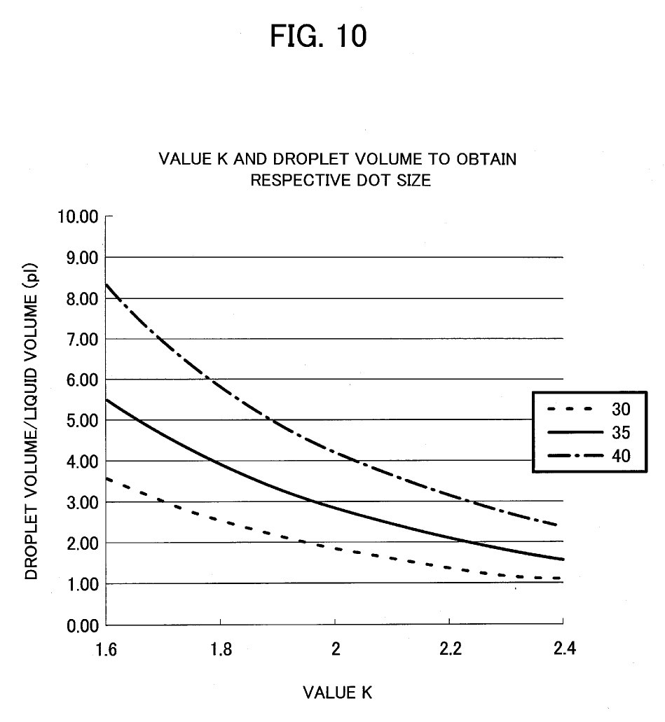

The above facts will be described in more detail. FIG. 10 is a line chart showing the relation between a value K and ink liquid volume to obtain respective dot size. In this example, the value K=dot size of discharged ink/ink diameter to be discharged (the diameter on the presumption that the ink has a spherical shape) holds. The lines in FIG. 10 respectively show relations between the value K and the ink liquid volume to obtain 30 μm, 35 μm and 40 μm dot size.

In the present exemplary embodiment, the resolution of an image to be formed is 1200 dpi. In this case, a minimum dot size (diagonal line in the grid of 1200 dpi) to complete solid recording is about 30 μm. In consideration of variation in ink application by about 5 μm, about a 35 μm dot size is necessary.

According to the measurement by the present inventors, when the ink is discharged and then the dampening solution is discharged, the value K is 2.0. Accordingly, the ink liquid volume necessary for solid recording when the ink is discharged and then the dampening solution is discharged is a little under 3 pl (pico liter). On the other hand, when the dampening solution is discharged and then the ink is discharged, the value K is 1.8. Accordingly, the ink droplet volume necessary for solid recording when the dampening solution is discharged and then the ink is discharged is a little under 4 pl.

That is, when the ink is discharged and then the dampening solution is discharged, solid image can be completed with a little under 3 pl ink. On the other hand, when the dampening solution is discharged and then the ink is discharged, solid image may not be completed with a little under 3 pl ink, and for completion of the solid image, a little under 4 pl ink is preferred.

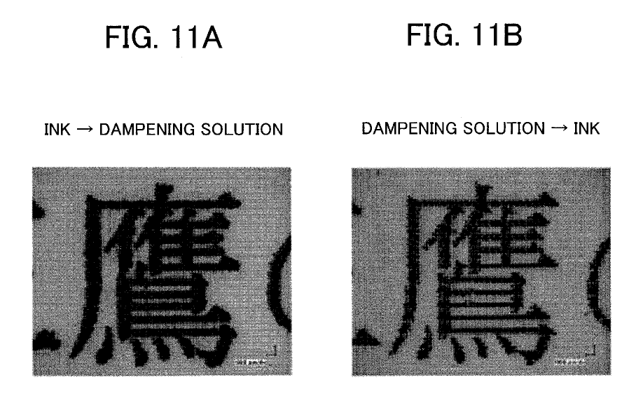

FIG. 11A shows a state where a character is formed with a predetermined liquid droplet amount in the case where the ink is discharged and then the dampening solution is discharged. FIG. 11B shows a state where the character is formed with the same amount as the liquid droplet amount in FIG. 11A in the case where the dampening solution is discharged and then the ink is discharged. When the ink is discharged and then the dampening solution is discharged, the lines of the character may be thick and dense. On the other hand, when the dampening solution is discharged and then the ink is discharged, the lines of the character may be thin and pale. In this manner, when the ink is discharged and then the dampening solution is discharged, the character may be clearly formed in comparison with the case where the dampening solution is discharged and then the ink is discharged.

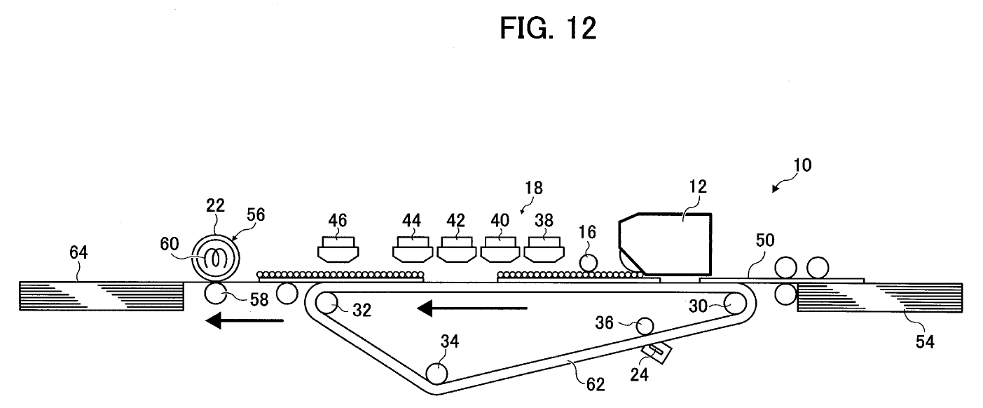

FIG. 12 shows the image forming apparatus 10 according to a second exemplary embodiment of the present invention.

In the above-described first exemplary embodiment, the image forming apparatus uses the intermediate transfer member 14. In the second exemplary embodiment, the intermediate transfer member 14 is not used. That is, the recording medium 50 is transported with a transporting member 62 in place of the intermediate transfer member 14, then the liquid absorbing particles are supplied to the recording medium 50, then a liquid is discharged by the inkjet recording device 18 to the liquid absorbing particles on the recording medium 50, thus an image is formed.

The recording medium supply part 54 is provided on the right side of the transporting member 62, and the recording medium 50 is supplied from the recording medium supply part 54 to the transporting member 62. Then the liquid absorbing particles supplied by the liquid absorbing particle supplying device 12 are supplied onto the recording medium 50 supplied to the transporting member 62. The pressure part 16 applies a pressure to the liquid absorbing particles on the recording medium 50 and thereby the density of the liquid absorbing particles is increased. Then a liquid corresponding to an image is applied by the inkjet recording device 18. The fixing device 22 is provided on the left side of the transporting member 62, and the liquid-applied liquid absorbing particles are fixed to the recording medium 50 with heat and pressure. The recording medium 50 to which the liquid absorbing particles have been fixed by the fixing device 22 is discharged to a recording medium discharge unit 64.

Note that regarding the already-described constituent elements, the same reference numerals are given in the drawings and the explanations of these elements are omitted.

In the above-described exemplary embodiments, the recording heads are provided on the upstream side of the recording head(s) for the dampening solution; however, the present invention is not limited to this arrangement. Any arrangement maybe used as long as the ink is discharged before the dampening solution is discharged. For example, it may be arranged such that the recording heads and the recording head(s) for the dampening solution are mechanically exchanged and the ink and the dampening solution are discharged in the same position on the intermediate transfer body or the recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a supply unit that supplies liquid receiving particles to receive a liquid;
a transporting unit that transports the liquid receiving particles supplied by the supply unit; and
a ejecting unit that ejects liquid droplets to the liquid receiving particles transported by the transporting unit, the ejecting unit having:
an ink ejecting part that ejects ink; and
a dampening solution ejecting part that ejects a dampening solution to dampen the liquid receiving particles,
the ink ejecting part being provided on an upstream side of the dampening solution ejecting part in the liquid receiving particles transporting direction of the transporting unit.

2. The image forming apparatus according to claim 1, wherein the ejecting unit ejects the ink from the ink ejecting part to an image region in which an image is formed on a recording medium, and ejects the dampening solution from the dampening solution ejecting part to a non-image region in which an image is not formed on the recording medium.

3. The image forming apparatus according to claim 2, wherein in the ejecting unit, a ejecting amount per a unit area of the ink ejected from the ink ejecting part to the image region and a ejecting amount per the unit area of the dampening solution ejected from the dampening solution ejecting part to the non-image region are approximately the same.

4. The image forming apparatus according to claim 1, wherein the ejecting unit ejects the ink from the ink ejecting part to an image region in which the image is formed on a recording medium, and ejects the dampening solution from the dampening solution ejecting part to the image region and a non-image region in which an image is not formed on the recording medium.

5. The image forming apparatus according to claim 4, wherein in the ejecting unit, a total amount of a ejecting amount per a unit area of the ink ejected from the ink ejecting part and a ejecting amount per the unit area of the dampening solution ejected from the dampening solution ejecting part to the image region is approximately the same as a ejecting amount per the unit area of the dampening solution ejected from the dampening solution ejecting part to the non-image region.

6. The image forming apparatus according to claim 1, wherein the ink ejecting part is provided in at least two positions in the liquid receiving particles transporting direction of the transporting unit, and
a distance between the ink ejecting part provided on the most downstream side in the liquid receiving particles transporting direction of the transporting unit and the dampening solution ejecting part is longer than a distance between at least two ink ejecting parts.

7. An image forming method comprising:
supplying liquid receiving particles to receive a liquid;
transporting the liquid receiving particles supplied in the supplying; and
ejecting liquid droplets to the liquid receiving particles transported in the transporting,
the ejecting having:
ejecting ink; and
ejecting a dampening solution.

8. The image forming method according to claim 7, wherein the ejecting ejects the ink to an image region in which an image is formed on a recording medium, and ejects the dampening solution to a non-image region in which an image not formed on the recording medium.

9. The image forming method according to claim 8, wherein in the ejecting, an ejecting amount per a unit area of the ink ejected to the image region and an ejecting amount per a unit area of the damping solution ejected to the non-image region are approximately the same.

10. The image forming method according to claim 7, wherein the ejecting ejects the ink to an image region in which the image is formed on a recording medium, and ejects the dampening solution to the image region and a non-image region in which an image.

11. The image forming method according to claim 10, wherein in the ejecting, a total amount of an ejecting amount per a unit area of the ink ejected and an ejecting amount per the unit area of the dampening solution ejected to the image region is approximately the same as a ejecting amount per the unit area of the dampening solution ejected to the non-image region.

12. The image forming method according to claim 7, wherein the ejecting ink is at least twice, a time between the end of the ejecting ink and the ejecting dampening solution is longer than a time between at least two ejecting ink.
